(19) United States
(12) Patent Application Publication
(10) Pub. No.: US 2014/0158186 A1
(43) Pub. Date: Jun. 12, 2014

(54) COUNTER ELECTRODE AND DYS-SENSITIZED SOLAR CELL USING THE SAME

(71) Applicants: NATIONAL TAIWAN UNIVERSITY, Taipei City (TW); NATIONAL TAIWAN NORMAL UNIVERSITY, Taipei City (TW)

(72) Inventors: Chun-wei CHEN, Taipei City (TW); Chia-chun CHEN, Taipei City (TW); Di-yan WANG, Taipei City (TW); Ying-chiao WANG, Taipei City (TW)

(73) Assignees: National Taiwan Normal University, Taipei City (TW); National Taiwan University, Taipei City (TW)

(21) Appl. No.: 13/785,180

(22) Filed: Mar. 5, 2013

(30) Foreign Application Priority Data
Dec. 7, 2012 (TW) 101146084

(51) Int. Cl. H01G 9/20

(52) U.S. Cl. CPC H01G 9/2022
USPC 136/254; 136/252

(57) ABSTRACT

Disclosed are a counter electrode and a dye-sensitized solar cell. The dye-sensitized solar cell includes a photo electrode, the counter electrode and an electrolytic solution. The counter electrode is disposed correspondingly to the photo electrode. The counter electrode includes a conductive layer and a catalytic layer. The catalytic layer is formed on a surface of the conductive layer facing the photo electrode. The catalytic layer includes FeS₂. The electrolytic solution is disposed between the photo electrode and the counter electrode. The present invention is capable of significantly decreasing manufacturing costs of the counter electrode and the dye-sensitized solar cell.

### FIELD OF THE INVENTION

The present invention generally relates to a solar cell, and more particularly to a dye-sensitized solar cell (DSSC).

### BACKGROUND

A solar cell is a device which converts solar energy to electrical energy. A dye-sensitized solar cell is a new type of solar cell.

The dye-sensitized solar cell mainly comprises a photo electrode, a counter electrode and an electrolytic solution. The electrolytic solution is disposed between the photo electrode and the counter electrode. The photo electrode comprises nano-particles of TiO2 with dye adsorption. When sunlight is irradiated to the photo electrode, electrons of dye of the photo electrode are transferred from a ground state to an excited state. Then, the electrons are transferred to the counter electrode for achieving electron transportation. The dye which loses the electrons receives electrons from the electrolytic solution, after which it returns to the ground state.

Generally speaking, a catalytic layer is coated on the counter electrode for enhancing efficiency of the dye-sensitized solar cell. Currently, platinum (Pt) is a mostly used material for the catalytic layer. Selecting the platinum for the catalytic layer not only provides a better catalytic surface but also decreases a voltage loss due to an overpotential.

However, since the platinum is expensive, a lot of researches propose various materials for substituting for the platinum, such as cobalt sulfide, nickel sulfide and so on. These proposed materials are not abundant resources in the earth. Accordingly, cost of the dye-sensitized solar cell cannot be reduced.

Consequently, there is a need to solve the above-mentioned problem that the material used for the catalytic layer of the counter electrode is expensive and rare such that the cost of the dye-sensitized solar cell cannot be reduced.

### SUMMARY OF THE INVENTION

An object of the present invention is to provide a counter electrode and a dye-sensitized solar cell using the same, which are capable of solving the problem that the expensive and rare platinum is utilized for the catalytic layer, such that the cost of the dye-sensitized solar cell cannot be reduced

To achieve the above-mentioned object, an aspect of the present invention is to provide a counter electrode. The counter electrode comprises a conductive layer and a catalytic layer. The catalytic layer is formed on a surface of the conductive layer. The catalytic layer comprises FeS₂.

To achieve the above-mentioned object, another aspect of the present invention is to provide a dye-sensitized solar cell. The dye-sensitized solar cell comprises a photo electrode, a counter electrode and an electrolytic solution. The counter electrode is disposed correspondingly to the photo electrode. The counter electrode comprises a conductive layer and a catalytic layer. The catalytic layer is formed on a surface of the conductive layer facing the photo electrode. The catalytic layer comprises FeS₂. The electrolytic solution is disposed between the photo electrode and the counter electrode.

In the counter electrode and the dye-sensitized solar cell of the present invention, the FeS₂ is utilized as the material of the catalytic layer. Since the FeS₂ is abundant mine in the earth, the manufacturing cost of the dye-sensitized solar cell can be significantly reduced, thereby effectively solving the problem that the platinum or other noble metals are not acquired easily due to high cost.

### BRIEF DESCRIPTION OF THE DRAWINGS

FIG. 1 illustrates a dye-sensitized solar cell in accordance with an embodiment of the present invention;

FIG. 2A illustrates current-voltage characteristics of the dye-sensitized solar cell by using the platinum as the counter electrode in the prior arts under dark conditions and current-voltage characteristics of the dye-sensitized solar cell by using the FeS₂ as the counter electrode under dark conditions in the present invention;

FIG. 2B illustrates current-voltage characteristics of the dye-sensitized solar cell by using the platinum as the counter in the prior arts under light intensity of 100 mw/cm² and current-voltage characteristics of the dye-sensitized solar cell by using the FeS₂ as the counter electrode in the present invention under light intensity of 100 mw/cm²;

FIG. 3 illustrates cyclic voltammogram curves of the dye-sensitized solar cell by using the platinum as the counter electrode in the prior arts and the dye-sensitized solar cell by using the FeS₂ as the counter electrode in the present invention;

FIG. 4 illustrates Tafel curves of the dye-sensitized solar cell by using the platinum as the counter electrode in the prior arts and the dye-sensitized solar cell by using the FeS₂ as the counter electrode in the present invention;

FIG. 5A illustrates the cyclic voltammogram curve of the dye-sensitized solar cell by using the FeS₂ as the counter electrode in the present invention;

FIG. 5B illustrates relationships between cycle times of the redox and current intensity;

FIG. 6 illustrates transmittances of the dye-sensitized solar cell by using the platinum as the counter electrode in the prior arts and transmittances of the dye-sensitized solar cell by using the FeS₂ as the counter electrode in the present invention;

FIG. 7 illustrates in a condition of illumination from a back side, the current-voltage characteristics of the back-illuminated type dye-sensitized solar cell by using the platinum as the counter electrode in the prior arts and the current-voltage characteristics of the back-illuminated type dye-sensitized solar cell by using the FeS₂ as the counter electrode in the present invention; and

FIG. 8 illustrates in a condition of illumination from both affront and a back side, the current-voltage characteristics of a double-sided illuminated type dye-sensitized solar cell by using the platinum as the counter electrode in the prior arts and the current-voltage characteristics of the double-sided illuminated type dye-sensitized solar cell by using the FeS₂ as the counter electrode in the present invention.

### DETAILED DESCRIPTION OF THE INVENTION

The technical scheme of the present invention will be further described in detail as follow by giving embodiments with reference to the accompanying drawings.

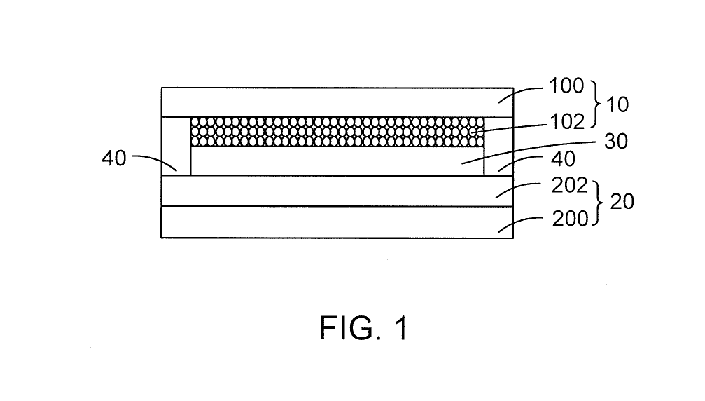

Please refer to FIG. 1, which illustrates a dye-sensitized solar cell in accordance with an embodiment of the present invention.

The dye-sensitized solar cell of the present invention comprises a photo electrode 10, a counter electrode 20 and an electrolytic solution 30.

The photo electrode 10 comprises a conductive layer 100 and a porous semiconductor layer 102. The porous semiconductor layer 102 is formed on a surface of the conductive layer 100. More particularly, the porous semiconductor layer 102 is formed on the surface of the conductive layer 100 of the photo electrode 10 facing the counter electrode 20. The porous semiconductor layer 102 comprises a plurality of metal oxide nano-particles with dye adsorption. In the present embodiment, the metal oxide nano-particles with dye adsorption are titanium dioxide nano-particles (TiO₂). In another embodiment, the metal oxide nano-particles with dye adsorption may be other suitable metal oxide nano-particles. The dye is known by one skilled in the art of the present invention and not repeated herein.

The counter electrode 20 is disposed correspondingly to the photo electrode 10 and comprises a conductive layer 200 and a catalytic layer 202. The catalytic layer 202 is formed on a surface of the conductive layer 200. More particularly, the catalytic layer 202 is formed on the surface of the conductive layer 200 facing the photo electrode 10. In the present embodiment, the conductive layer 200 is a flexible and transparent substrate. For instance, the conductive layer 200 is, but not limited to, an indium tin oxide (ITO) substrate, a fluorine-doped tin oxide (FTO) substrate and so on. In another embodiment, the conductive layer 200 may be a non-transparent and/or rigid substrate.

A key feature of the dye-sensitized solar cell of the present invention is that the catalytic layer 202 comprises iron pyrites (FeS₂). Preferredly, the FeS₂ comprises nanocrystals of FeS₂. The nanorystals of FeS₂ have a particle size of from about 1 nanometer (nm) to about 100 nm. The counter electrode 20 comprises the conductive layer 200 and the nanorystals of FeS₂ coated on the conductive layer 200 (such as the above-mentioned ITO substrate). The nanorystals of FeS₂ and the conductive layer 200 are together formed a nano-composite material. In another embodiment, the FeS₂ serving as the catalytic layer 202 has a particle size of from about 100 nm to about 100 micrometers (μm).

In the dye-sensitized solar cell of the present invention, the FeS₂ is utilized for the catalytic layer 202, thereby substituting for the expensive platinum serving as the catalytic layer of the counter electrode in the prior arts. Since the catalytic ability of the FeS₂ is excellent and the FeS₂ is abundant mine in the earth, the manufacturing cost of the dye-sensitized solar cell can be significantly reduced. Moreover, the nanorystals of FeS₂ have a geometric shape with high roughness, such that the catalytic ability may be further enhanced.

In one embodiment, the above-mentioned nanorystals of FeS₂ may be spin-coated on a conductive substrate, for instance, an ITO substrate or an FTO substrate, in a room temperature, thereby forming a film with high catalytic ability. The above-mentioned process is a soluble process. Since the counter electrode 20 together formed by the nanorystals of FeS₂ and the ITO substrate may be manufactured via the soluble process, the counter electrode 20 may be applied to a counter electrode of a soft dye-sensitized solar cell.

In the above-mentioned embodiment, the FeS₂ may be spin-coated on the conductive substrate, for instance, the ITO substrate or FTO substrate, thereby forming a uniform and transparent film. Accordingly, the uniform and transparent film may be applied to a back-illuminated type dye-sensitized solar cell and applied to a fuel cell, paint, a catalytic and transparent film and so on.

The electrolytic solution 30 is disposed between the photo electrode 10 and the counter electrode 20. The electrolytic solution 30 comprises a redox couple consisting of iodide ions and triiodide ions. The FeS₂ utilized by the present invention has excellent catalytic ability to catalyze reduction of the triiodide ions. In another embodiment, the electrolytic solution 30 comprises a redox couple consisting of ferricyanide/ferrocyanide (Fe(CN)₆ ^{4-/3-}) or a redox couple consisting of polysulfide electrolyte (S²⁻/Sₓ²⁻).

The dye-sensitized solar cell of the present invention may further comprise a sealing layer 40. The sealing layer 40 is disposed between the photo electrode 10 and the counter electrode 20 and at least disposed at two sides of the electrolytic solution 30 and the porous semiconductor layer 102. The sealing layer 40 is utilized for sealing the electrolytic solution 30 and the porous semiconductor layer 102 for preventing the electrolytic solution 30 from leaking. In another embodiment, the sealing layer 40 may be disposed at two sides of the porous semiconductor layer 102, the catalytic layer 202 and the electrolytic solution 30 for sealing the porous semiconductor layer 102, the catalytic layer 202 and the electrolytic solution 30.

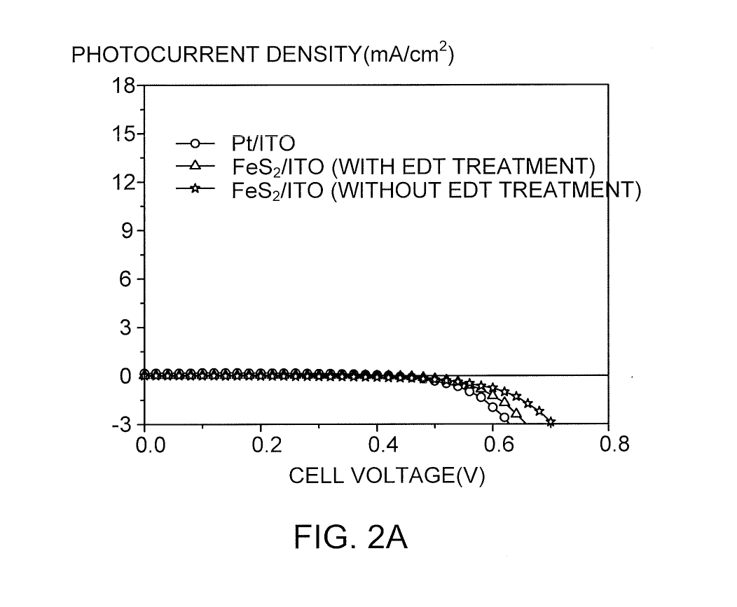

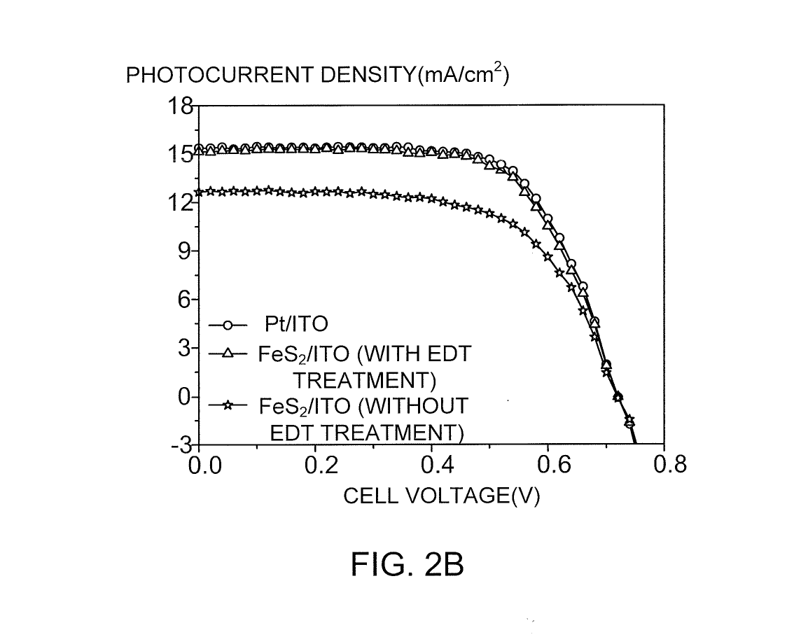

Please refer to FIG. 2A and FIG. 2B. FIG. 2A illustrates current-voltage characteristics of the dye-sensitized solar cell by using the platinum (Pt) as the counter electrode in the prior arts under dark conditions and current-voltage characteristics of the dye-sensitized solar cell by using the FeS₂ as the counter electrode under dark conditions in the present invention. FIG. 2B illustrates current-voltage characteristics of the dye-sensitized solar cell by using the platinum as the counter in the prior arts under light intensity of 100 mw/cm² (milliwatt per centimeter squared) and current-voltage characteristics of the dye-sensitized solar cell by using the FeS₂ as the counter electrode in the present invention under light intensity of 100 mw/cm². It can be understood from FIG. 2A and FIG. 2B that the current-voltage characteristics of the dye-sensitized solar cell by using the FeS₂ as the counter electrode in the present invention are approximately equivalent to the current-voltage characteristics of the dye-sensitized solar cell by using the platinum as the counter electrode in the prior arts. Moreover, it can be understood from experiments that a photoelectric conversion efficiency of the dye-sensitized solar cell by using the FeS₂ as the counter electrode in the present invention is approximately equivalent to a photoelectric conversion efficiency of the dye-sensitized solar cell by using the platinum as the counter electrode in the prior arts. It is noted that “EDT” in FIG. 2A and FIG. 2B refers to 1,2-ethanedithiol. The EDT treatment is known for one skilled in the art and not repeated herein.

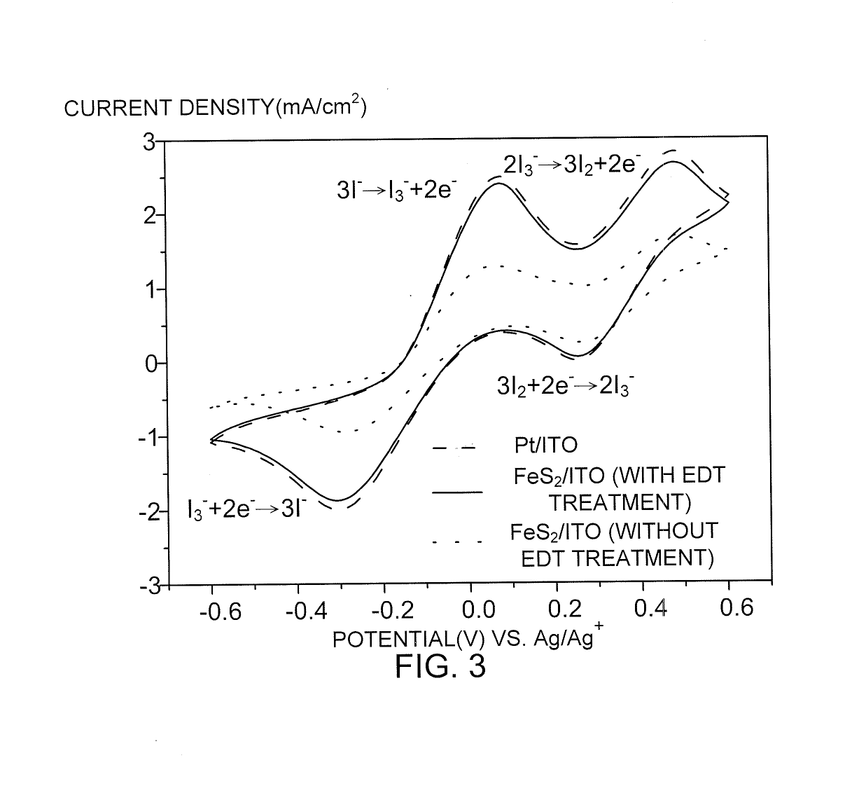

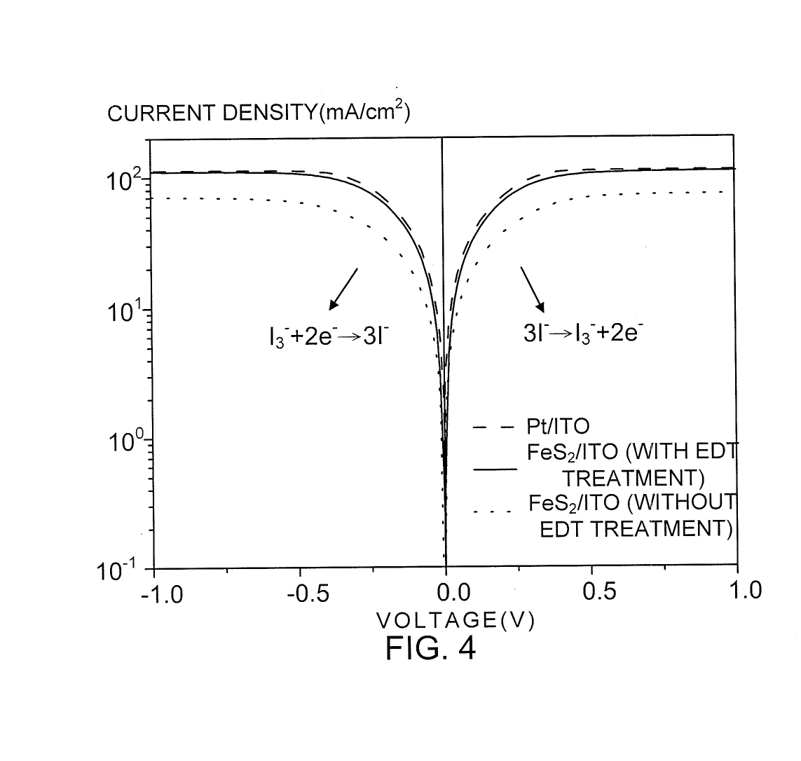

Please refer to FIG. 3 and FIG. 4. FIG. 3 illustrates cyclic voltammogram curves of the dye-sensitized solar cell by using the platinum as the counter electrode in the prior arts and the dye-sensitized solar cell by using the FeS₂ as the counter electrode in the present invention. FIG. 4 illustrates Tafel curves of the dye-sensitized solar cell by using the platinum as the counter electrode in the prior arts and the dye-sensitized solar cell by using the FeS₂ as the counter electrode in the present invention. It can be understood that reduction characteristics of the dye dye-sensitized solar cell by using the FeS₂ as the counter electrode in the present invention are approximately equivalent to reduction characteristics of the dye dye-sensitized solar cell by using the platinum as the counter electrode in the prior arts.

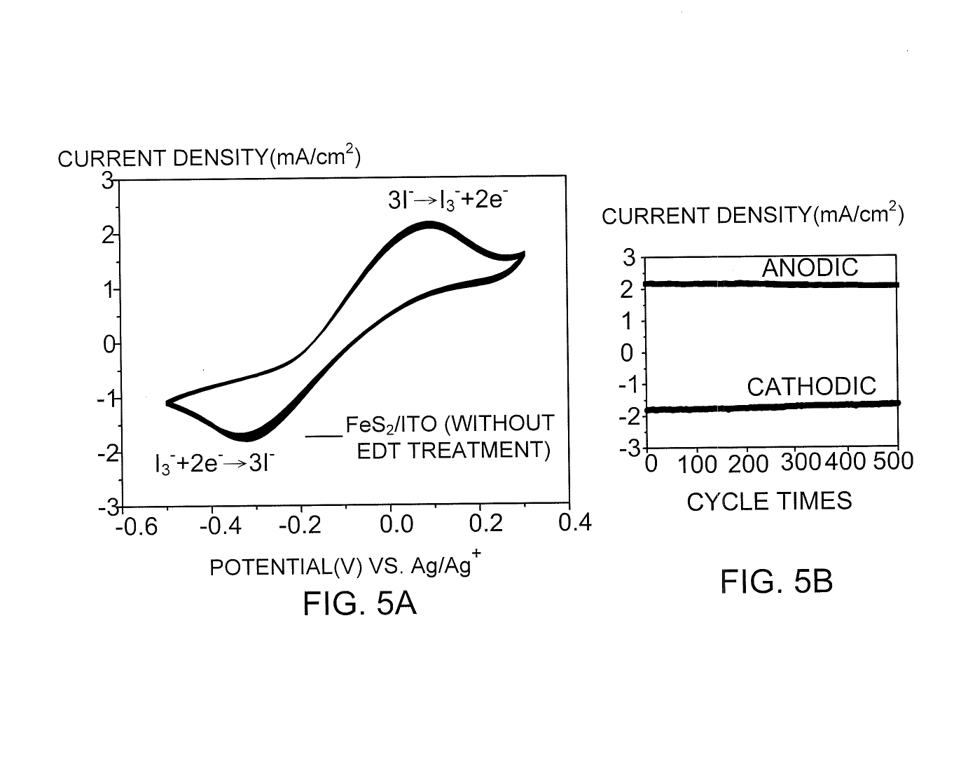

Please refer to FIG. 5A and FIG. 5B. FIG. 5A illustrates the cyclic voltammogram curve of the dye-sensitized solar cell by using the FeS₂ as the counter electrode in the present invention. FIG. 5B illustrates relationships between cycle times of the redox and current intensity. It can be understood that the current intensity after 500 times of the redox is approximately equivalent to the current intensity in an initial condition.

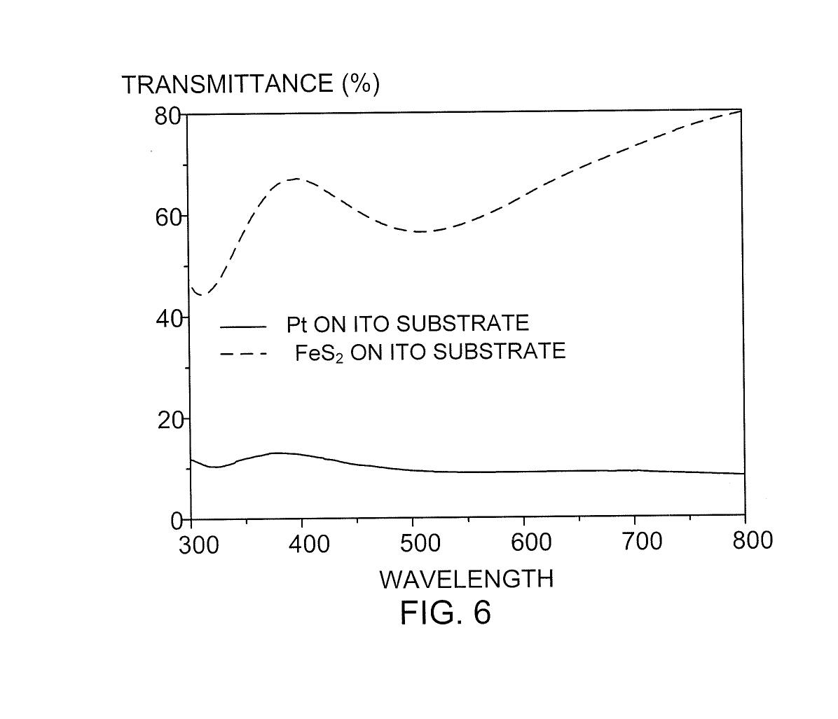

Please refer to FIG. 6, which illustrates transmittances of the dye-sensitized solar cell by using the platinum as the counter electrode in the prior arts and transmittances of the dye-sensitized solar cell by using the FeS₂ as the counter electrode in the present invention. It can be seen from FIG. 6 that the transmittances of the FeS₂ which is formed on the ITO substrate are more superior than the transmittances of the platinum which is formed on the ITO substrate. As a result, the FeS₂ is suitable to apply to a back-illuminated type dye-sensitized solar cell.

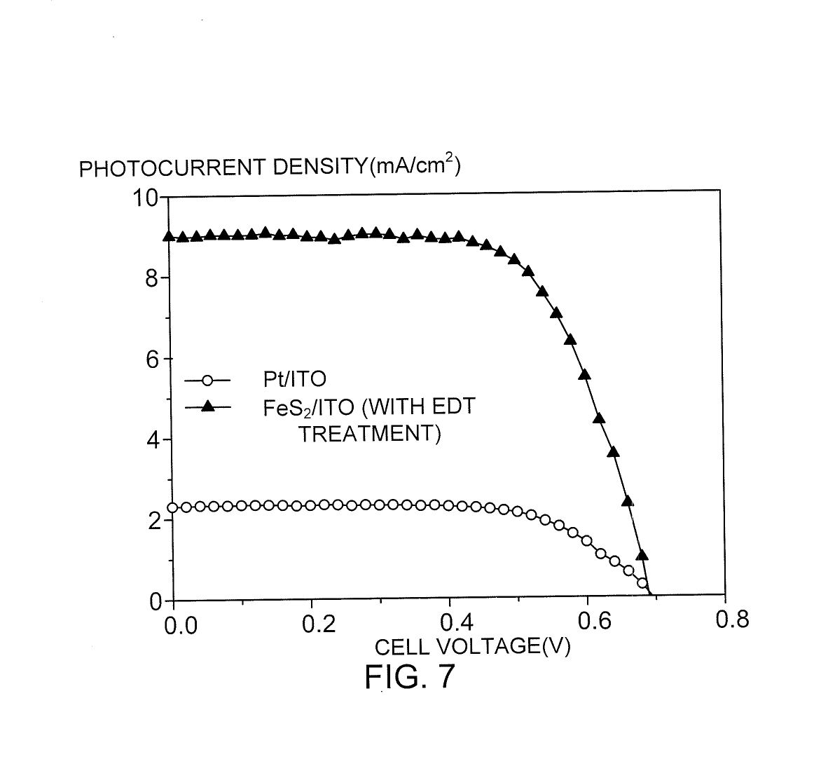

Please refer to FIG. 7, which illustrates in a condition of illumination from a back side, the current-voltage characteristics of the back-illuminated type dye-sensitized solar cell by using the platinum as the counter electrode in the prior arts and the current-voltage characteristics of the back-illuminated type dye-sensitized solar cell by using the FeS₂ as the counter electrode in the present invention. Since the transmittance of the FeS₂ which is formed on the ITO substrate is more superior than the transmittance of the platinum which is formed on the ITO substrate, the current-voltage characteristics of the back-illuminated type dye-sensitized solar cell by using the FeS₂ as the counter electrode in the present invention are more superior than the current-voltage characteristics of the back-illuminated type dye-sensitized solar cell by using the platinum as the counter electrode in the prior arts, as shown in FIG. 7.

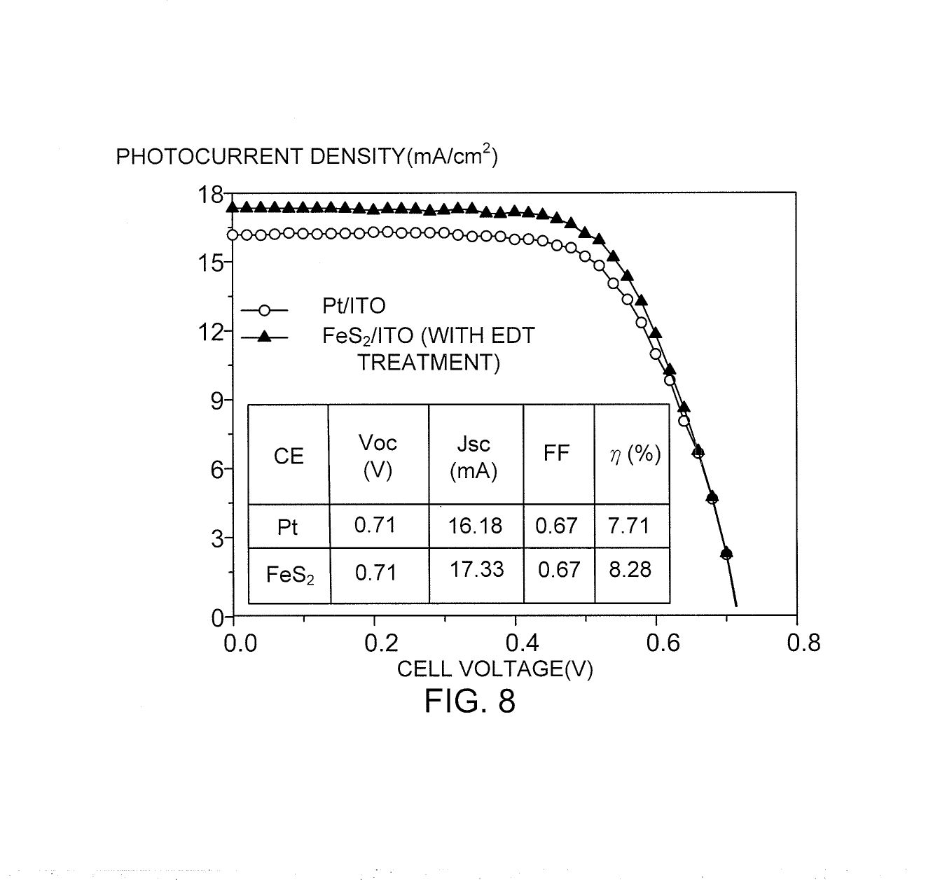

Please refer to FIG. 8, which illustrates in a condition of illumination from both affront and a back side, the current-voltage characteristics of a double-sided illuminated type dye-sensitized solar cell by using the platinum as the counter electrode in the prior arts and the current-voltage characteristics of the double-sided illuminated type dye-sensitized solar cell by using the FeS₂ as the counter electrode in the present invention. It can be understood from FIG. 8 that the current-voltage characteristics and the photoelectric conversion efficiency in the present invention are more superior than the current-voltage characteristics and the photoelectric conversion efficiency in the prior arts.

In the counter electrode and the dye-sensitized solar cell of the present invention, the FeS₂ is utilized as the material of the catalytic layer. Since the FeS₂ is abundant mine in the earth, the manufacturing cost of the dye-sensitized solar cell can be significantly reduced, thereby effectively solving the problem that the platinum or other noble metals are not acquired easily due to high cost. Moreover, the nanorystals of FeS₂ have a geometric shape with high roughness, such that the catalytic ability may be further enhanced.

As is understood by a person skilled in the art, the foregoing preferred embodiments of the present invention are illustrative rather than limiting of the present invention. It is intended that they cover various modifications and similar arrangements be included within the spirit and scope of the appended claims, the scope of which should be accorded the broadest interpretation so as to encompass all such modifications and similar structure.

1. A counter electrode, comprising:
a conductive layer; and
a catalytic layer, formed on a surface of the conductive layer, the catalytic layer comprising FeS₂, wherein the FeS₂ comprises nanocrystals of FeS₂, and the nanocrystals of FeS₂ have a particle size of from about 1 nm to about 100 nm.

2. (canceled)

3. (canceled)

4. (canceled)

5. The counter electrode of claim 1, wherein the conductive layer is a transparent substrate.

6. The counter electrode of claim 1, wherein the conductive layer is a flexible substrate.

7. A dye-sensitized solar cell, comprising:
a photo electrode;
a counter electrode, disposed correspondingly to the photo electrode, the counter electrode comprising:
a conductive layer; and
a catalytic layer, formed on a surface of the conductive layer facing the photo electrode, the catalytic layer comprising FeS₂, wherein the FeS₂ comprises nanocrystals of FeS₂, and the nanocrystals of FeS₂ have a particle size of from about 1 nm to about 100 nm; and
an electrolytic solution, disposed between the photo electrode and the counter electrode.

8. (canceled)

9. (canceled)

10. (canceled)

11. The dye-sensitized solar cell of claim of claim 7, wherein the conductive layer is a transparent substrate.

12. The dye-sensitized solar cell of claim 7, wherein the conductive layer is a flexible substrate.

13. The dye-sensitized solar cell of claim 7, wherein the photo electrode comprises:
a conductive layer; and
a porous semiconductor layer, formed on a surface of the conductive layer of the photo elect rode facing the counter electrode, the porous semiconductor layer comprising a plurality of metal oxide nano-particles with dye adsorption.

14. The dye-sensitized solar cell of claim 13, further comprising a sealing layer, wherein the sealing layer is disposed at two sides of the electrolytic solution and the porous semi conductor layer for sealing the electrolytic solution and the porous semiconductor layer.

15. The dye-sensitized solar cell of claim 7, wherein the electrolytic solution comprises a redox couple consisting of iodide ions and triiodide ions.

16. The dye-sensitized solar cell of claim 7, wherein the electrolytic solution comprises a redox couple consisting of Fe(CN)₆^{4-/3-}.

17. (canceled)
